(19) United States
(12) Patent Application Publication
(10) Pub. No.: US 2012/0149214 A1
(43) Pub. Date: Jun. 14, 2012

(54) CABLE ASSEMBLY ADAPTED FOR POWER AND SIGNAL TRANSMITTING

(75) Inventors: WEI ZHANG, Kunshan (CN); DAVID KO, Fullerton, CA (US)

(73) Assignee: HON HAI PRECISION INDUSTRY CO., LTD., New Taipei (TW)

(21) Appl. No.: 13/323,637

(22) Filed: Dec. 12, 2011

(30) Foreign Application Priority Data
Dec. 10, 2010 (CN) 201020653520.X

(51) Int. Cl. H01R 12/75; H01R 3/00; H01R 33/945

(52) U.S. Cl. 439/55; 439/577; 439/488

(57) ABSTRACT

A cable assembly (100) includes at least one connector (2) for transmitting signal; a cover (3) holding the connector; a cable (4) electrically or optically connected with the connector; a LED enclosed by the cover; and a light pipe (7) including a main portion and a protrusion upwardly extending from the main portion, the main portion defining a recess opened downwardly to accommodate the LED therein, and the protrusion inserted into a corresponding bore in the cover and exposed outwardly

### BACKGROUND OF THE INVENTION

1. Field of the Invention

The present invention relates to a cable assembly, especially to a cable assembly adapted for power and signal transmitting.

2. Description of Related Art

CN patent No. 200820303305.X issued on Oct. 28, 2009 to Su et al. discloses a cable assembly which comprises a first cable connector, a circuit board installed inside the first cable connector, a shielding shell surrounded outside the circuit board and an insulating shell positioned outside the shielding shell; wherein, the end of the circuit board is connected with two cables penetrating out of the shielding shell, the other ends of the two cables are respectively connected with a second cable connector being in accordance with the displayport standard and a third cable connector being in accordance with the USB standard. The cable assembly has the improved structure and is provided with an additional USB connector for supplying power source.

However, there is no indicating device to show working status of the cable assembly, and users are unable to identify whether the cable assembly is working or not when it is connected to a corresponding electronic device.

Hence, a cable assembly with an indicator is required to overcome the problem of the prior art.

### SUMMARY OF THE INVENTION

An object of the present invention is to provide a cable assembly with an indicator to show working status.

Accordingly, to achieve above-mentioned object, a cable assembly comprises at least one connector for transmitting signal; a cover holding the connector; a cable electrically or optically connected with the connector; a LED enclosed by the cover; and a light pipe including a main portion and a protrusion upwardly extending from the main portion, the main portion defining a recess opened downwardly to accommodate the LED therein, and the protrusion inserted into a corresponding bore in the cover and exposed outwardly

The detailed features of the present invention will be apparent in the detailed description with appropriate reference to the accompanying drawings.

### BRIEF DESCRIPTION OF THE DRAWINGS

FIG. 1 is a perspective view of a cable assembly which includes a first connector for power transmitting and a second connector for signal transmitting in accordance with the present invention;

FIG. 2 is similar to FIG. 1, but viewed from other aspect;

FIG. 3 is a top side view of the cable assembly, with a dustproof cap covering a corresponding mating port of the second connector;

FIG. 4 is a partially exploded, perspective view of the cable assembly;

FIG. 5 is similar to FIG. 4, but viewed from other aspect;

FIG. 6 is another partially exploded, perspective view of the cable assembly;

FIG. 7 is a cross-section view of the FIG. 1 taken along a line 7-7;

FIG. 8 is a cross-section view of the FIG. 2 taken along a line 8-8;

FIG. 9 is an exploded, perspective view of the second connector in FIG. 1;

FIG. 10 is similar to FIG. 9, but viewed from other direction;

FIG. 11 is an exploded, perspective view of a switch device in FIG. 4;

FIG. 12 is similar to FIG. 11, but viewed from other aspect;

FIG. 13 is an enlarged view of a top cover and the dustproof cap; and

FIG. 14 is partially enlarged view of an engagement section between the top cover and the dustproof cap.

### DETAILED DESCRIPTION OF THE INVENTION

Reference will now be made in detail to the preferred embodiment of the present invention.

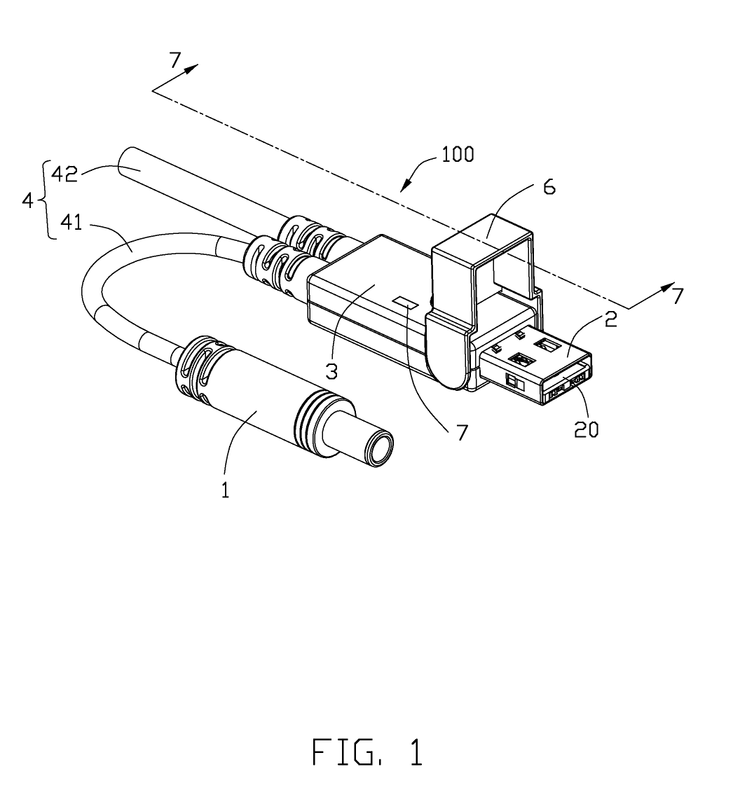

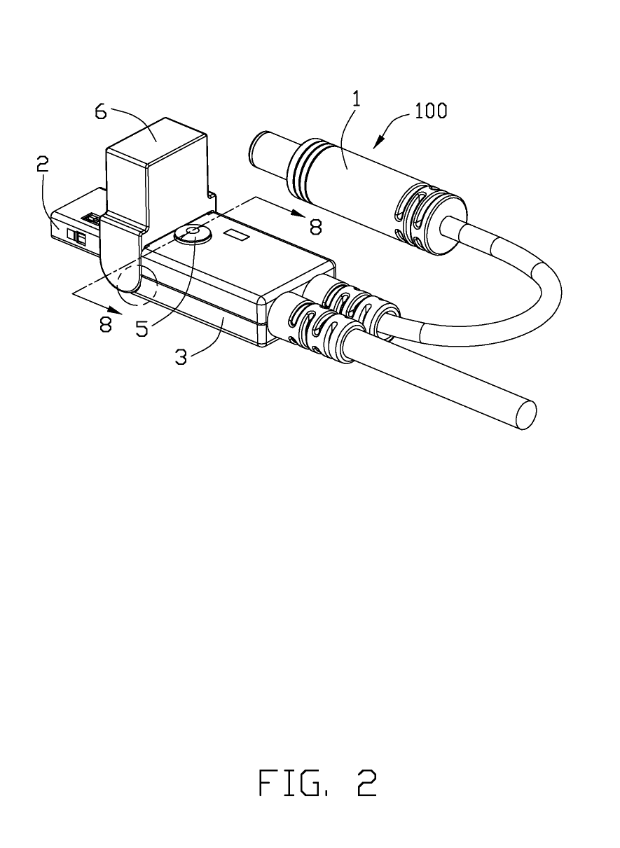

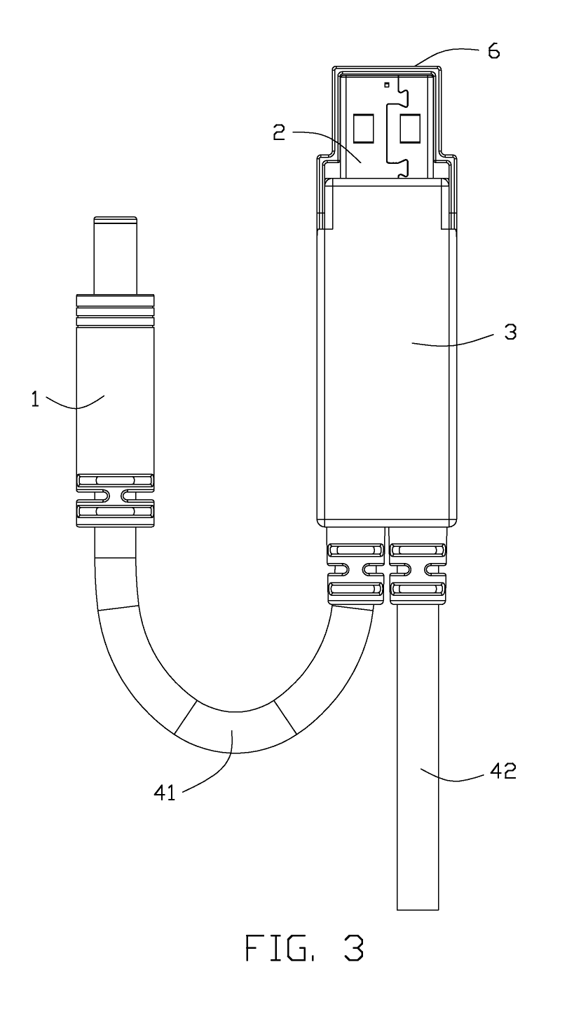

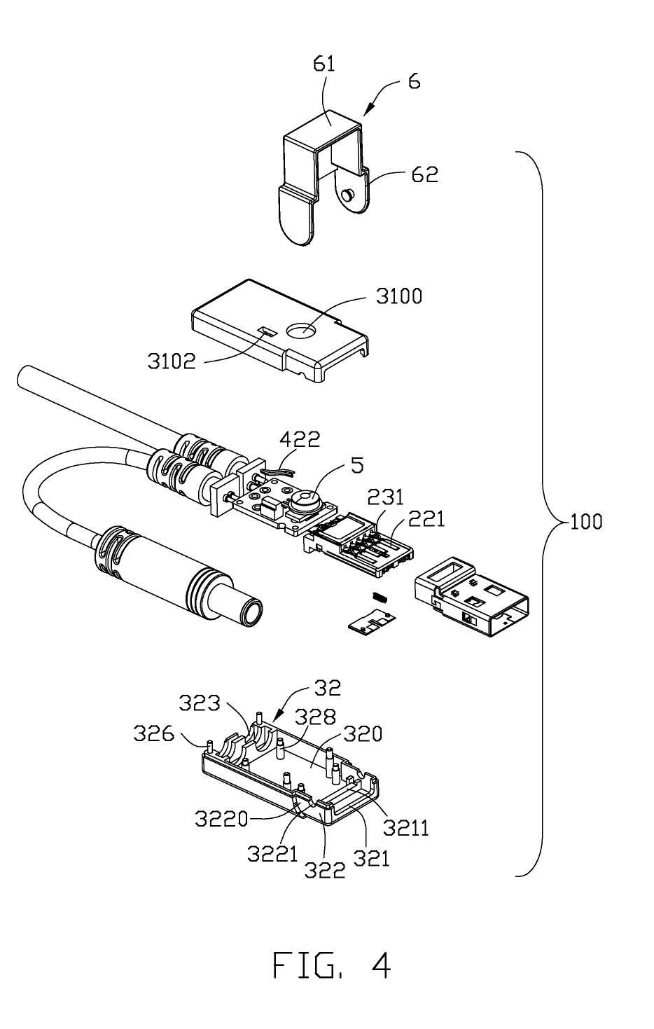

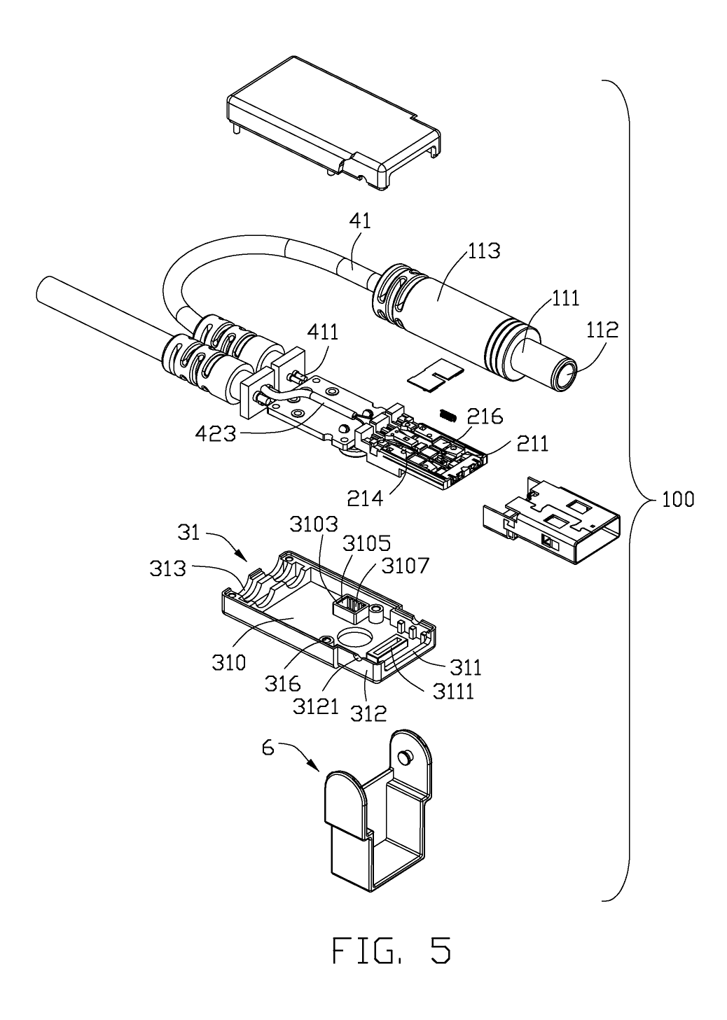

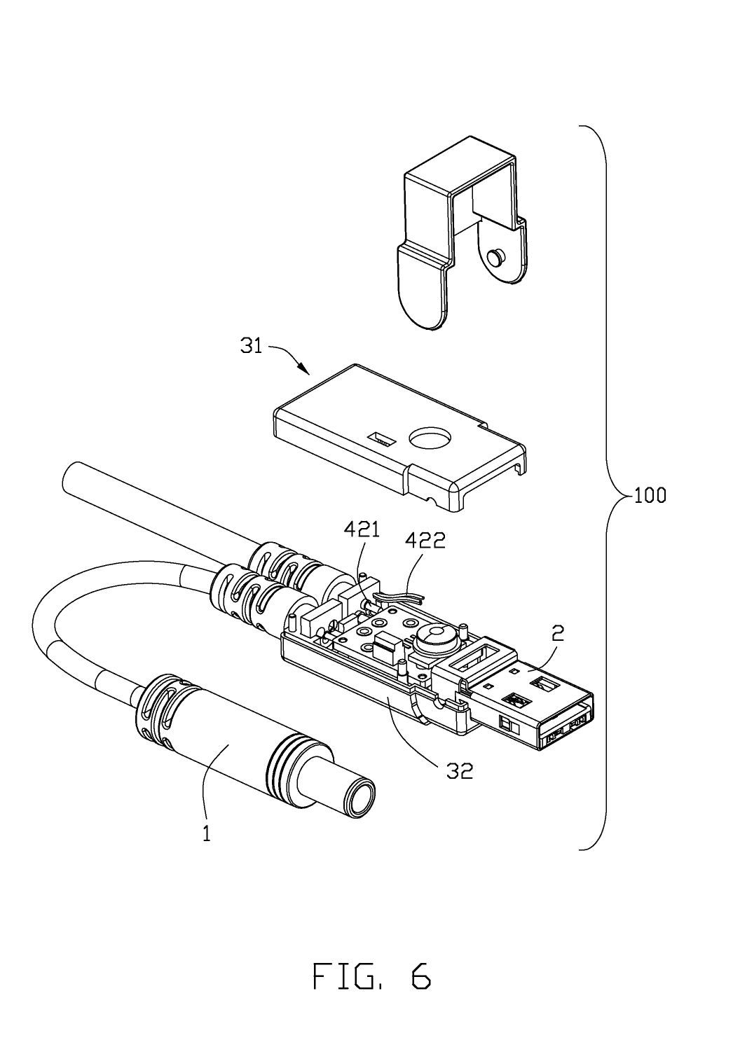

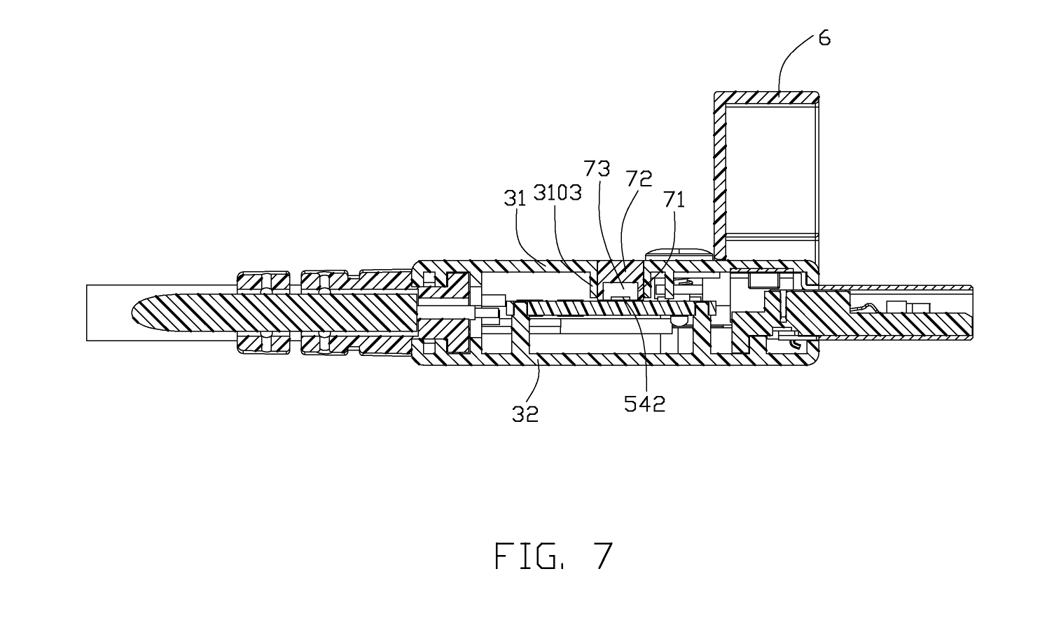

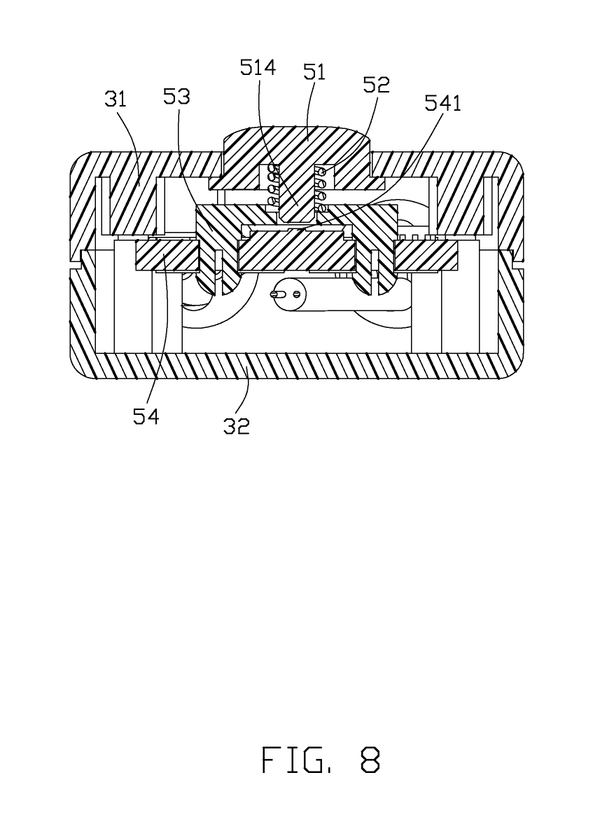

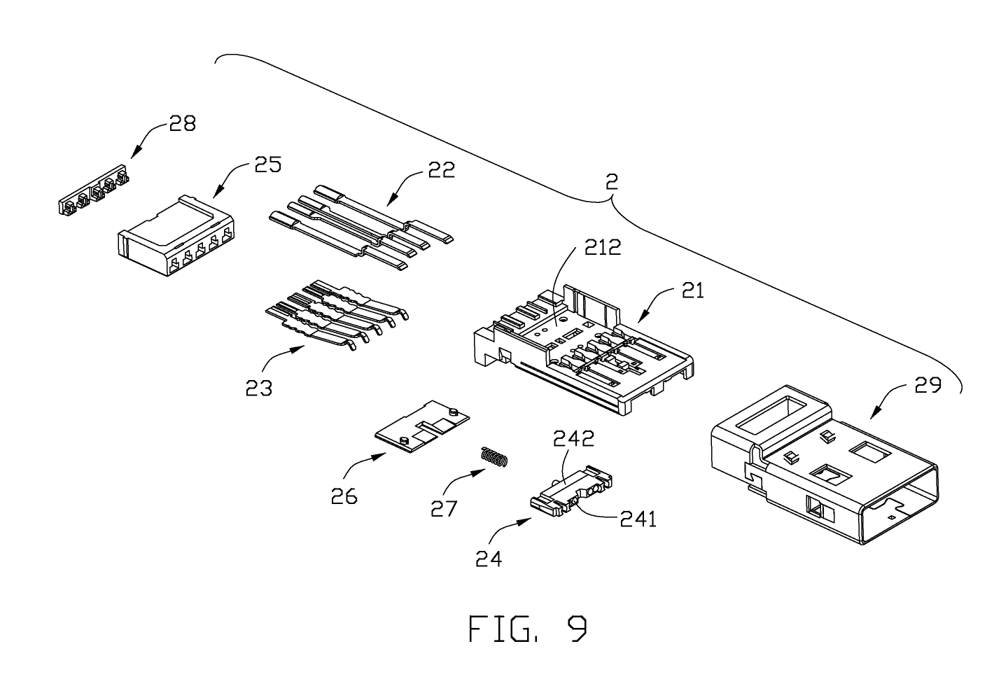

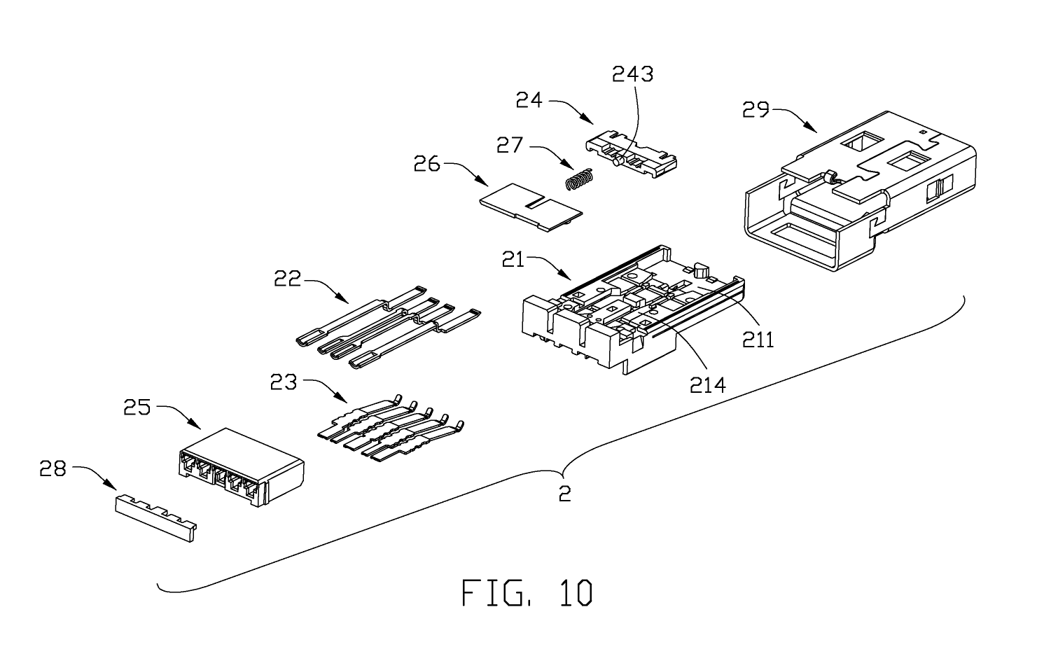

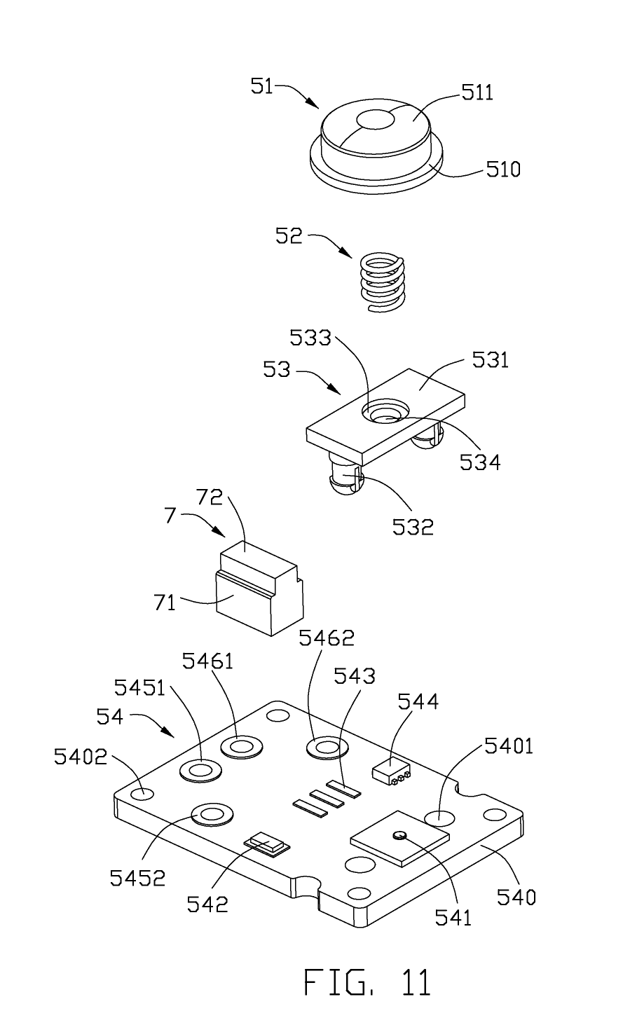

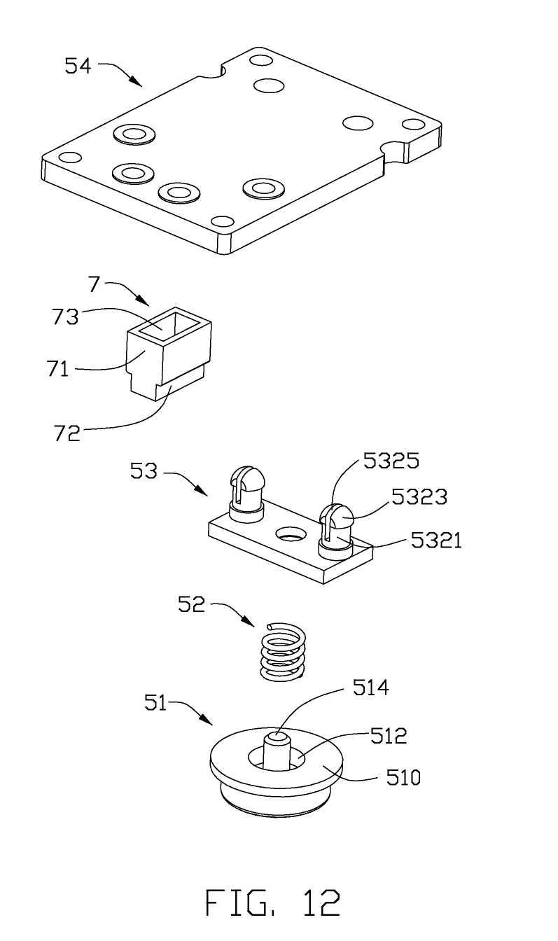

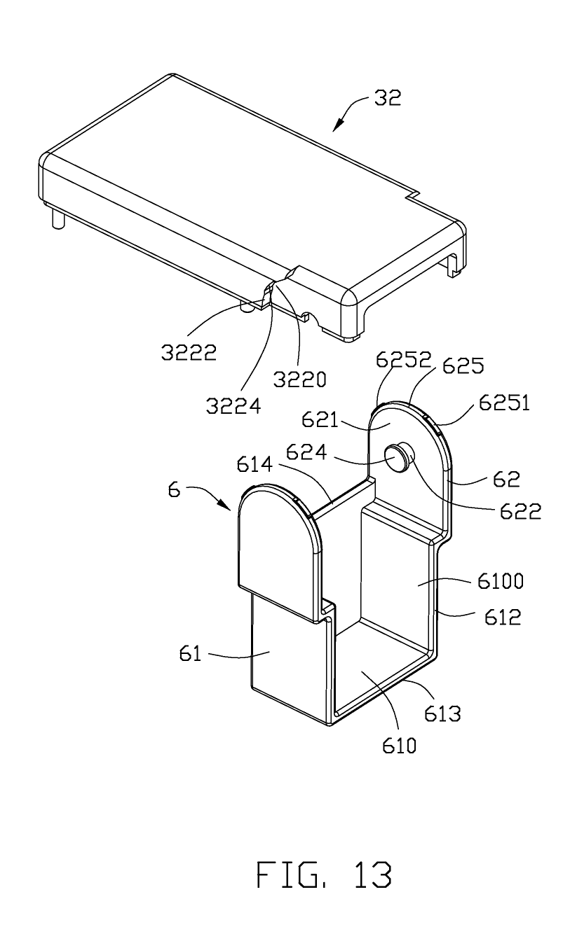

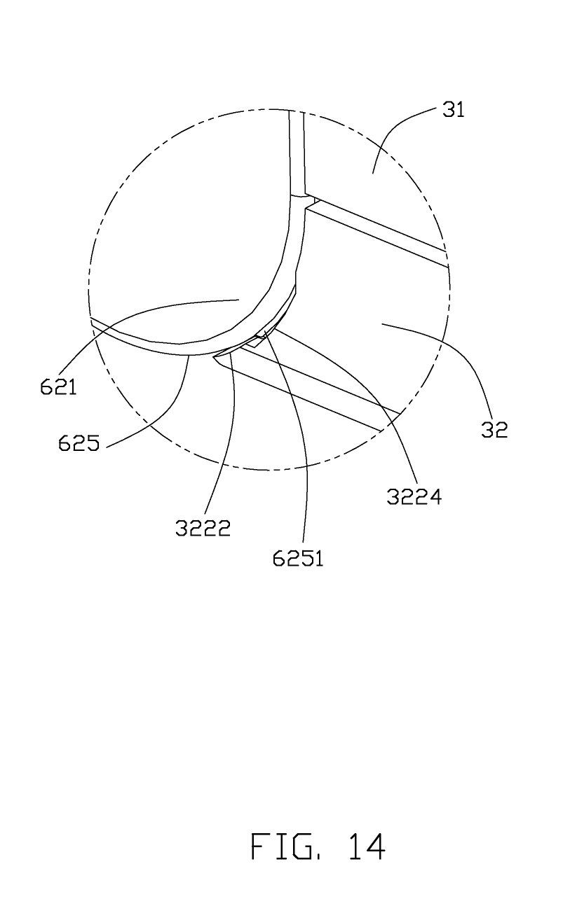

Referring to FIGS. 1-14, a cable assembly 100 in accordance with the present invention comprises a first connector 1, a second connector 2, a cover 3 for holding the second connector 2, two cables 4, a switch device 5, a dustproof cap 6 and a light pipe 7. The cables 4 includes a first cable 41 and a second cable 42 dimensioned larger than the first cable 41. The first cable 41 has two opposite ends respectively connected to the first connector 1 and the second connector 2, and the second cable 42 connected to the second connector 2.

The first connector 1 is a power connector, and it transmits DC power in the present invention. The first connector 1 includes an elongated cylindrical shaped body portion 111 with a circular mating port 112. One of the ends of the first cable 41 is electrically connected to an end of the first connector 1, with an insulative boot 113 attached to a connecting area between the first cable 41 and the body portion 111.

The second connector 2 is adapted for transmitting signal. The second connector 2 includes an insulative housing 21, a set of first pins 22 mounted to the insulative housing 21, a set of second pins 23 combined with a contact seat 25 and assembled to the insulative housing 21; in addition, a positioning member 28 is mounted to a back segment of the contact seat 25 to secure the second pins 23. The insulative housing 21 defines a mounting cavity 212 in a back segment thereof to accommodate the contact seat 25. The first pins 22 and the second pins 23 arranged offset from each other along a front-to-back direction.

The second connector 2 further includes an optical module 24 accommodated in a cavity 211 located in a front segment of the insulative housing 21. The optical module 24 has a number of lenses 241 arranged in a row and enclosed in a lens seat 242. The second cable 42 has a fiber cable 423 with fibers (not numbered) which pass through corresponding grooves 214 in the insulative housing 21 and extend into the cavity 211 to couple with the lenses 241. A retaining board 26 is positioned in a depression 216 of the insulative housing 21 so as to confine the optical module 24 and the fibers 43. There is a coil spring 27 employed to bias the optical module 24. The coil spring 27 is sandwiched between the optical module 24 and the insulative housing 21, with a post 243 formed on a back side of the lens seat 242 and inserted into a front end of the coil spring 27.

The cover 3 includes a top cover 31 and a bottom cover 32 assembled together.

The top cover 31 defines a first receiving space 310 which communicates with an exterior via a first rectangular shaped opening 311 in a front side of the top cover 31 and two first semicircular shaped outlets 313 in a back side of the top cover 31. There is a first positioning portion 3111 located in the first receiving space 310 and behind the first opening 311. There is a circular shaped window 3100 defined in a front segment of a top side of the top cover 31; and a rectangular shaped bore 3102 located in a lateral section of the top cover 31 and behind the window 3100. There is a rectangular shaped retainer 3103 formed on a bottom surface of the top side and extending downwardly therefrom, and the retainer 3103 defines a cavity 3105 which is located under and communicates with the bore 3102. The cavity 3105 is larger than the bore 3102. In addition, there are a plurality of frictional ribs 3107 formed on an inner surface of the cavity 3105. There are a number of positioning holes 316 located in the first receiving space 310 and adjacent to lateral sides of the top cover 31. There is a first depression 312 defined in an outer of a front section of each lateral side of the top cover 31, and a first semicircular shape hole 3121 located in a middle and bottom of the front section of the lateral side. The first semicircular shape hole 3121 communicates with the first depression 312 and the first receiving space 310.

The bottom cover 32 defines a second receiving space 320 which communicates with an exterior via a second rectangular shaped opening 321 in a front side of the bottom cover 32 and two second semicircular shaped outlets 323 in a back side of the bottom cover 32. There is a second positioning portion 3211 located in the second receiving space 320 and behind the second opening 321. There are a plurality of positioning posts 326 arranged adjacent to lateral sides of the bottom cover 32. There is a second depression 322 defined in an outer of a front section of each lateral side of the bottom cover 32, and a second semicircular shape hole 3221 located in a middle of the front section of the lateral side. The second semicircular shape hole 3221 communicates with the second depression 322 and the second receiving space 320. There is a positioning cavity 3220 located in a back section of the second depression 322, and the positioning cavity 3220 is a sector which occupies about a quarter of a circular area viewed from lateral direction, with a corresponding center of the circular area located at the second semicircular shape hole 3221. Accordingly, the positioning cavity 3220 has an arc shape rear edge 3222 which is about one fourth of a circular shape. In addition, there is a notch 3224 defined in a middle of the arc shaped rear edge 3222.

The second connector 2 is accommodated in the first receiving space 310 and the second receiving space 320, with a mating port 20 thereof exposed outside the cover 3.

The switch device 5 includes a button 51, a spring 52, a supporting member 53 and a PCBA (printed circuit board assembly) 54.

The button 51 includes a main portion 510 and a head portion 511 formed on a top side of the main portion 510. The main portion 510 and the head portion 511 are both circular shape, and the head portion 511 is smaller than the main portion 510. There is a circular cavity 512 recessed upwardly from a bottom surface of the main portion 510, and a cylindrical post 514 located in a center of the circular cavity 512 and further projecting beyond the bottom surface of the main portion 510. The spring 52 is a coil spring and adapted for being assembled to the cylindrical post 514, and an upper section of the spring 52 accommodated in the circular cavity 512.

The supporting member 53 includes a board 531, two latching arms 532 extending downwardly from the board 531 and spaced apart from each other. There is a blind positioning cavity 533 located in the board 531 and a through hole 534 further defined in the positioning cavity 533. The positioning cavity 533 and the through hole 534 are circular shape, and the positioning cavity 533 is larger than the through hole 534. A lower end of the spring 52 is accommodated in the positioning cavity 533. The post 514 can pass through the through hole 534. There is a slot 5325 defined in the latching arm 532 to separate it into two deformable sub-arms 5321. Each sub-arm 5321 has an enlarged free end 5323.

The PCBA (printed circuit board assembly) 54 includes a circuit substrate 540, a switch member 541 mounted to a front section of the circuit substrate 540, a LED (Lighting Emitting Diode) 542 arranged at a right side of the circular substrate 540 and disposed behind the switch member 541. Three conductive pads 543 are formed on a middle segment of the circuit substrate 540 and located behind the switch member 541. There is an ESD (Electro Static Discharge) member 544 mounted to a left side of the circuit substrate 540 and transversally aligning with the LED 542. Two first positioning holes 5401 located in the circuit substrate 540 and disposed at opposite sides of the switch member 541. Four second positioning holes 5402 are respectively located in four corners of the circuit substrate 540. A pair of first conductive portions 5451, 5452 are arranged at a right side of a back segment of the circuit substrate 540. A pair of second conductive portions 5461, 5462 are arranged at a left side of the back segment of the circuit substrate 540. The first conductive portion 5451 and the second conductive portion 5461 are plated metallic holes, electrically linked with each other by an inner line (not shown) of the circuit substrate. The first conductive portion 5451 and the second conductive portion 5461 are adapted for negative power. The first conductive portion 5452 and the second conductive portion 5462 are plated metallic holes, electrically linked with each other by an inner line (not shown) of the circuit substrate 540. The first conductive portion 5452 and the second conductive portion 5462 are adapted for positive power. The first conductive portion 5451 and the second conductive portion 5461 are transversally aligned with each other, located behind and parallel with the first conductive portion 5452 and the second conductive portion 5462 transversally aligned with each other. Furthermore, a distance between the first conductive portion 5451 and the second conductive portion 5461 is smaller than that of the first conductive portion 5452 and the second conductive portion 5462, therefore, the first conductive portions 5451, 5452 and the second conductive portions 5461, 5462 are trapezoidally disposed.

The circuit substrate 540 is accommodated in the second receiving space 320 of the bottom cover 32, with four standoffs 328 of the bottom cover 32 respectively inserted into the four second positioning holes 5402 of the circuit substrate 540. The supporting member 53 is assembled to the circuit substrate 540, with the latching arms 532 inserted into the first positioning holes 5401, the enlarged free end 5323 abutting a bottom surface of the circuit substrate 540, the board 531 disposed above the a switch member 541 and the through hole 534 aligning with the switch member 541 along a up-to-down direction. The button 51 together with the spring 52 is assembled to the supporting member 53 with the lower portion of the spring 52 received in the positioning cavity 533 in the board 531, the post 514 through the spring 52 and entering the through hole 534 so as to actuate or touch the switch member 541. The spring 52 is arranged between the button 51 and the supporting member 53 to constantly upwardly push the button 51. The spring 52 is larger than through hole 534 so that it does not enter therein. The top cover 31 is assembled to the bottom cover 32, with the head portion 511 exposed outward via the window 3100 and the main portion 510 against a bottom surface of the top wall of the top cover 31.

The first cable 41 has two wires 411 with two front ends thereof respectively soldered to the first conductive portion 5451 and the second conductive portion 5452, and two back ends of the two wires are soldered to the first connector 1.

The second cable 42 includes a pair of first wires 421, three second wires 422 and a fiber cable 423. The first wires 421 are used for transmitting power. Two front ends of first wires 421 are soldered to the first conductive portion 5461 and the second conductive portion 5462. The three second wires 422 are soldered to the three conductive pads 543 which are further electrically connected to the switch device 5, the LED 542 and a corresponding grounding bus via inner lines of the circuit substrate 54.

The first cable 41 and the second cable 42 are electrically connected with each other by the PCBA 54. In addition, the second cable 42 may contain additional wires (not shown) for connecting with the first pins 22 and the second pins 23.

The dustproof cap 6 includes a shielding portion 61 and two mounting arms 62 connecting with the shielding portion 61.

The shielding portion 61 includes two side walls 612, a front wall 613 and a top wall 614 jointed with each other to form a receiving space 610 thereamong. The shielding portion 61 has a bottom opening 6100 and a back opening (not numbered). Each mounting arm 62 is of L-shaped. The mounting arm 62 is connected with the side wall 612. A transversal distance between the two mounting arms 62 is larger than a transversal distance between two the side walls 612.

Each mounting arm 62 defines a semicircular shaped flange 621. The flange 621 has a semicircular shaped end edge 625. There are a first protrusion 6251 and a second protrusion 6252 formed on the end edge 625. The first protrusion 6251 and the second protrusion 6252 are spaced apart from each other about ninety degree, i.e., the first protrusion 6251 is located at forty five degree of the semicircular shaped end edge 625 with regarding to a horizontal direction, and the second protrusion 6252 is located at one hundred and forty five degree of the semicircular shaped end edge 625 with regarding to the horizontal direction. There is pivot 622 formed on an inner surface of the semicircular shaped flange 621 and projects inwardly therefrom, and particularly, the pivot 622 is just located at a center of the semicircular shaped flange 621. The pivot 622 further has an expanded free end 624.

The dustproof cap 6 is assembled to the cover 3, with the mounting arm 62 accommodated in a corresponding depression formed by the first depression 312 and the second depression 322, the pivot 622 located in a corresponding circular mounting hole formed by a first semicircular shape hole 3121 and the second semicircular shape hole 3221, and the expanded free end 624 is disposed at inner lateral side of the corresponding circular mounting hole. The expanded free end 624 is larger than the circular mounting hole so as to prevent the pivot 622 separating from the corresponding circular mounting hole. Thus, the dustproof cover 6 is pivoted with the cover 3, and the semicircular shaped flange 621 is capable of rotating in the corresponding depression formed by the first depression 312 and the second depression 322, and the semicircular shaped end edge 625 rotates along the arc shape rear edge 3222 of the positioning cavity 3220. When the dustproof cap 6 does not enclose the mating port 20 of the second connector 2, the dustproof cap 6 is vertically disposed, with the bottom opening 6100 facing forwardly and the second protrusion 6252 engaging with the notch 3224 to prevent the dustproof cap 6 falling off freely. When the dustproof cap 6 encloses the mating port 20 of the second connector 2, the dustproof cap 6 is horizontally disposed, with the bottom opening 6100 facing downwardly and the first protrusion 6251 engaging with the notch 3224 to prevent the dustproof cap 6 freely movement.

The light pipe 7 is made of transparent material or translucent material and includes a main portion 71 and a protrusion 72 upwardly extending from the main portion 71. The main portion 71 defines a recess 73 opened downwardly. The protrusion 72 is a solid structure and smaller than the main portion 71. The recess 73 is larger than the LED 542. The light pipe 7 is supported by the circuit substrate 540, with the LED 542 being accommodated in the recess 73. The main portion 71 is positioned in the cavity 3105 of the retainer 3103. The protrusion 72 is inserted into the bore 3102 of the top cover 31 and exposed outwardly. In addition, there are some ribs 3107 formed on inner sides of the cavity 3105 for increasing friction between the light pipe 7 and the retainer 3103.

When the button 51 is pressed and the post 514 moves towards and actuates the switch member 541 so as to switch on a corresponding circuit of the PCBA 54 so as to start transmitting of the cable assembly 100, and the LEDs 542 is lighted and light emits or passes through the light pipe 7, and user may observe working status of the cable assembly 100. In the present embodiment, the LED 542 together with the light pipe 7 to form an indicator device which is visible from the exterior, but in alternative embodiment, only the LED may be served as an indicator device.

While a preferred embodiment in accordance with the present invention has been shown and described, equivalent modifications and changes known to persons skilled in the art according to the spirit of the present invention are considered within the scope of the present invention as described in the appended claims.

What is claimed is:

1. A cable assembly, comprising:
at least one connector for transmitting signal;
a cover holding the connector;
a cable electrically or optically connected with the connector;
a LED enclosed by the cover; and
a light pipe including a main portion and a protrusion upwardly extending from the main portion, the main portion defining a recess opened downwardly to accommodate the LED therein, and the protrusion inserted into a corresponding bore in the cover and exposed outwardly

2. The cable assembly as claimed in claim 1, further comprising a circuit substrate located inside the cover and electrically connected to the cable, and the LED is mounted to the circuit substrate.

3. The cable assembly as claimed in claim 2, further comprising a power connector connected to the circuit substrate via other cable.

4. The cable assembly as claimed in claim 1, wherein there is a retainer formed on a bottom surface of a top side of the cover and extending downwardly therefrom, and the retainer defines a cavity which is located under the bore and communicates with the bore.

5. The cable assembly as claimed in claim 1, wherein the retainer defines a cavity to receive the main portion of the light pipe.

6. The cable assembly as claimed in claim 5, wherein there are a number of ribs formed on inner sides of the cavity for increasing friction between the light pipe and the retainer.

7. The cable assembly as claimed in claim 2, wherein the light pipe is supported by the circuit substrate.

8. The cable assembly as claimed in claim 1, wherein the protrusion is smaller than the main portion.

9. The cable assembly as claimed in claim 1, wherein the light pipe is made of transparent or translucent material.

10. A cable assembly, comprising:
at least one connector for transmitting signal;
a top cover and a bottom cover combined together to hold the connector, the top cover defining a bore;
a cable electrically or optically connected with the connector;
an indicator device being visible from the bore of the top cover, and the indicator device including a LED and a light pipe disposed above the LED.

11. The cable assembly as claimed in claim 10, wherein the LED is enclosed in the light pipe.

12. The cable assembly as claimed in claim 11, wherein the light pipe includes a main portion and a protrusion upwardly extending from the main portion, and the main portion defines a recess opened downwardly to accommodate the LED therein, and the protrusion extends into the bore in the top cover and exposed outwardly

13. The cable assembly as claimed in claim 10, further comprising a circuit substrate, and the LED is mounted to the circuit substrate and the light pipe is supported by the circuit substrate.

14. The cable assembly as claimed in claim 10, further comprising a dustproof cap pivotally engaged with the top cover and the bottom cover for enclosing a mating port of the connector.

15. The cable assembly as claimed in claim 14, wherein the dustproof cap includes a shielding portion and two mounting arms connecting with the shielding portion.

16. The cable assembly as claimed in claim 15, wherein each mounting arm has a flange, and the first cover and a second cover together form a depression to accommodate the flange.

17. The cable assembly as claimed in claim 16, wherein the flange of the mounting arm has an end edge with a first protrusion and a second protrusion formed thereon, and there is a positioning cavity located in a back section of the depression, with a notch defined in a rear edge of the positioning cavity, and the first protrusion and the second protrusion can be selectively engaged with the notch.

18. A cable connector assembly comprising:
a connector transmitting both the electrical and optical signals and defining a mating port;
a printed circuit board positioned behind and connected with the connector at a front region of the printed circuit board;
a cable positioned behind and connected with a rear region of the printed circuit board;
a cover enclosing the printed circuit board, the connector except the mating port and a front portion of the cable;
a switch located upon the printed circuit board with a portion exposed upon the cover for external access;
an LED device mounted to the printed circuit board and exposing light to an exterior through the cover via a light pipe; and
a dustproof cap pivotally mounted to a front portion of the cover to selectively shield the mating port.

19. The cable connector assembly as claimed in claim 18, wherein said dustproof includes a pair of side arms linked to the cover, a vertical plate located between the pair of side arms and shielding a front opening of the mating port when the cap is located at a shielding position, and a horizontal plate located between and pair of side arms and seated upon a wall of the mating port under condition that the vertical plate, the horizontal plate and the pair of side arms are perpendicular to one another.
